(19) United States
(12) Patent Application Publication
(10) Pub. No.: US 2026/0046106 A1
(43) Pub. Date: Feb. 12, 2026

(54) TIME STAMP INTERPOLATION METHOD, TIME STAMP INTERPOLATION SYSTEM AND SENSOR SYSTEM

(71) Applicant: NTT, Inc., Tokyo (JP)

(72) Inventor: Kenichi Matsunaga, Tokyo (JP)

(21) Appl. No.: 19/150,058

(22) PCT Filed: Jan. 24, 2023
(86) PCT No.: PCT/JP2023/002047

§ 371 Date: Jul. 22, 2025

(51) Int. Cl. H04L 7/00; G06F 17/17; H04W 4/38

(52) U.S. Cl. CPC H04L 7/0029; G06F 17/17; H04W 4/38

(57) ABSTRACT

A method for interpolating time stamps added to respective data transmitted and received in a sensor system is provided. The method includes acquiring a first data received at an arbitrary time and a first time stamp associated with the first data, acquiring a second data received before the first data and a second time stamp associated with the second data, performing linear interpolation on the basis of the first time stamp, a value of the first data, the second time stamp, and a value of the second data, to acquire values of data at set time stamps requested by the sensor system, and outputting the values of data associated with the respective set time stamps to another device involved in the sensor system.

### CROSS-REFERENCE TO RELATED APPLICATIONS

This application is a national phase entry of PCT Application No. PCT/JP2023/002047, filed on Jan. 24, 2023, which application is hereby incorporated herein by reference.

### TECHNICAL FIELD

The present invention relates to a time stamp interpolation method, a time stamp interpolation system, and a sensor system in data transmission and reception.

### BACKGROUND

In an Internet of Things (IoT) network, various sensors are connected, and useful information is expected to be extracted by collecting a large variety of data and analyzing the data. Therefore, a terminal that houses a sensor is required to cope with various use cases and needs, and it is necessary to reduce power consumption in long-time measurement (Non Patent Literature 1).

In addition, there is disclosed a method of correcting a shifted time stamp with a sensor manufactured at a low cost in a sensor system. (Patent Literature 1)

### CITATION LIST

### Patent Literature

Patent Literature 1: Japanese Patent No. 6649517

### Non Patent Literature

Non Patent Literature 1: Kenichi Matsunaga et al., “IoTni Tekishita Maruchisensa Shuyo Deta Shushu Gijutsu No Teian (in Japanese) (Proposal of multi-sensor accommodation data collection technology suitable for IoT)”, The Institute of Electronics, Information and Communication Engineers (IEICE) Communication Society Convention, 2016, B-18-56.

### SUMMARY

### Technical Problem

In a general sensor system, a time stamp corrected by an arithmetic operation is a real value, and resolution is defined by a floating point on a computer, or the like.

On the other hand, a time stamp that can be received by a general server is limited to a millisecond order, a microsecond order, or the like.

In addition, a data format to be handled is defined in application fields such as industrial equipment and medical equipment. FIG. 18 illustrates acquired data (filled circles) plotted with corrected time stamps in a case where a data format to be handled is defined. Here, times T1 to TN indicate times of time stamps (set time stamps) requested (set) by the system. Since the interval between the time stamps is defined in the data format and actual values cannot be handled as time stamps, the corrected time stamps are different from the set time stamps. Therefore, the above-described time stamp correction technique cannot be applied.

### Solution to Problem

In order to solve the above-described problem, a time stamp interpolation method according to the present invention is a method of interpolating corrected time stamps of data in a time stamp interpolation system including an acquisition unit and an interpolation processing unit in a sensor system that transmits and receives the data, the method including: a step in which the acquisition unit acquires first data received at an arbitrary time and a first time stamp corrected after being added to the first data; a step in which the acquisition unit acquires second data received before the first data and a second time stamp corrected after being added to the second data; and a step in which the interpolation processing unit performs linear interpolation on the basis of the first time stamp, a value of the first data, the second time stamp, and a value of the second data to acquire values of data at set time stamps requested by the sensor system.

In addition, a time stamp interpolation system according to the present invention is a time stamp interpolation system in a sensor system that transmits and receives data, the time stamp interpolation system including: an acquisition unit configured to acquire first data received at an arbitrary time and a first time stamp corrected after being added to the first data and acquire second data received before the first data and a second time stamp corrected after being added to the second data; and an interpolation processing unit configured to perform linear interpolation on the basis of the first time stamp, a value of the first data, the second time stamp, and a value of the second data to acquire values of data at set time stamps requested by the sensor system.

### Advantageous Effects of Invention

According to the present invention, it is possible to provide a time stamp interpolation method, a time stamp interpolation system, and a sensor system capable of easily processing a time stamp in real time.

### BRIEF DESCRIPTION OF THE DRAWINGS

FIG. 1 is a block diagram illustrating a configuration of a sensor system according to a first embodiment of the present invention.

FIG. 2A is a flowchart illustrating a time stamp interpolation method according to the first embodiment of the present invention.

FIG. 2B is a diagram for describing the time stamp interpolation method according to the first embodiment of the present invention.

FIG. 3 is a block diagram illustrating a configuration of a sensor system according to a first example of the present invention.

FIG. 4A is a diagram for describing an operation of a time stamp correction system according to the first example of the present invention.

FIG. 4B is a diagram for describing the operation of the time stamp correction system according to the first example of the present invention.

FIG. 5 is a block diagram illustrating a configuration of the time stamp correction system according to a first example of the present invention.

FIG. 6 is a flowchart illustrating a time stamp correction method according to the first example of the present invention.

FIG. 7 is a diagram for describing the operation of the time stamp correction system according to the first example of the present invention.

FIG. 8A is a diagram for describing the operation of the time stamp correction system according to the first example of the present invention.

FIG. 8B is a diagram for describing the operation of the time stamp correction system according to the first example of the present invention.

FIG. 8C is a diagram for describing the operation of the time stamp correction system according to the first example of the present invention.

FIG. 8D is a diagram for describing the operation of the time stamp correction system according to the first example of the present invention.

FIG. 9 is a diagram for describing the operation of the time stamp correction system according to the first example of the present invention.

FIG. 10 is a diagram for describing the operation of the time stamp correction system according to the first example of the present invention.

FIG. 11 is a block diagram illustrating a configuration of a time stamp correction system according to a second example of the present invention.

FIG. 12 is a flowchart illustrating a time stamp correction method according to the second example of the present invention.

FIG. 13 is a diagram for describing a time stamp interpolation method according to a second embodiment of the present invention.

FIG. 14 is a diagram for describing a time stamp interpolation method according to a third embodiment of the present invention.

FIG. 15 is a flowchart illustrating the time stamp interpolation method according to the third embodiment of the present invention.

FIG. 16 is a schematic diagram illustrating a configuration of a sensor system according to a fourth embodiment of the present invention.

FIG. 17 is a schematic diagram illustrating a configuration of a sensor system according to a fifth embodiment of the present invention.

FIG. 18 is a diagram for describing an example of a conventional time stamp correcting method.

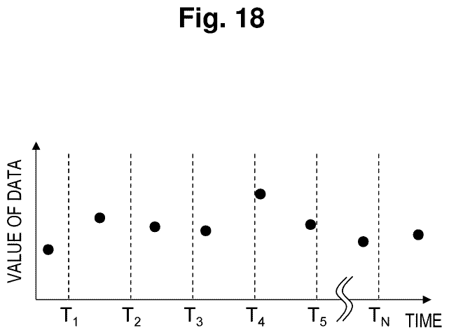

### DETAILED DESCRIPTION OF ILLUSTRATIVE EMBODIMENTS

### First Embodiment

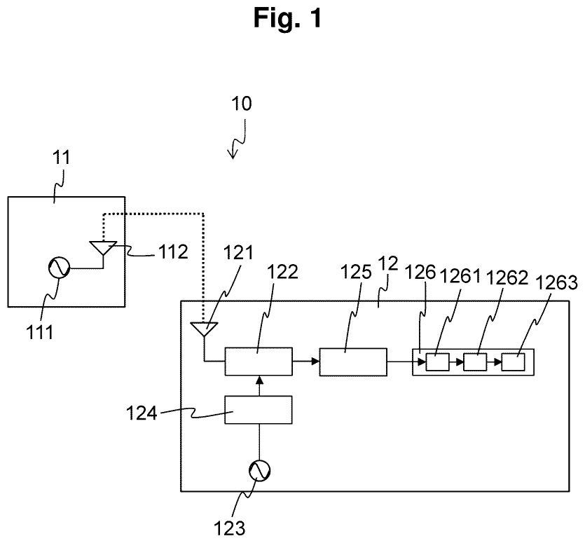

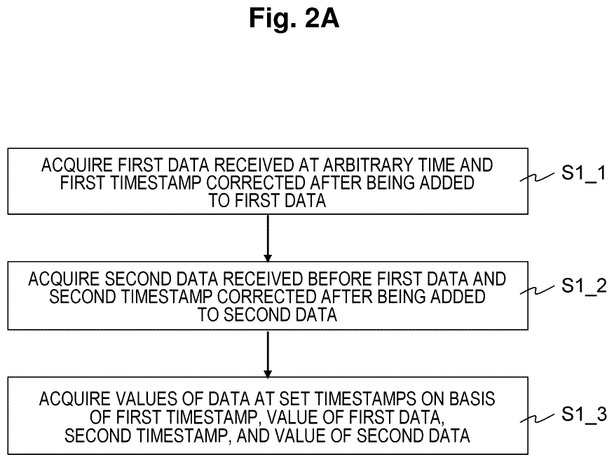

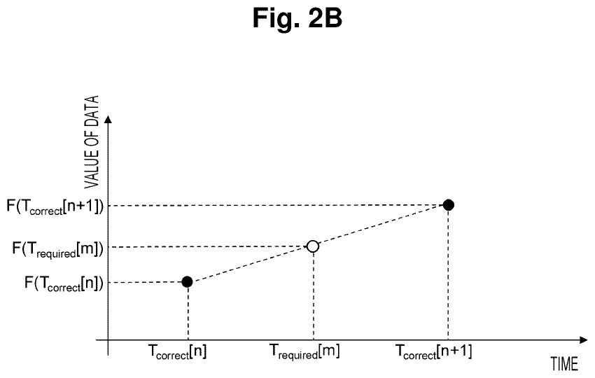

A time stamp interpolation method, a time stamp interpolation system, and a sensor system according to a first embodiment of the present invention will be described with reference to FIG. 1 to FIG. 2B.

### Configuration of Sensor System

As illustrated in FIG. 1, a sensor system 10 according to the present embodiment includes an intermittent operation terminal 11 and a receiver 12. Signals are transmitted and received between the intermittent operation terminal 11 and the receiver 12 in a wireless or wired manner.

The intermittent operation terminal 11 includes a clock unit 111 and a communication unit (transmission unit) 112.

In the intermittent operation terminal 11, the clock unit 111 generates T_{packet} that triggers an operation. The communication unit (transmission unit) 112 transmits packets (data) at intervals of T_{packet}. The intermittent operation terminal 11 is, for example, a sensor terminal.

The receiver 12 includes a reception unit 121, a time stamp adding unit 122, a time stamp clock 123, a time stamp correction system 125, and a time stamp interpolation system 126.

After the reception unit 121 receives a packet, the time stamp adding unit 122 adds a time stamp Tₛₜₐₘₚ counted by the time stamp clock 123 and provided via an OS 124 of the receiver to the packet. Here, time stamps are synchronized by the Global Positioning System (GPS), a network time protocol (NTP), a network identity and time zone (NITZ), or the like.

The time stamp correction system 125 corrects the time stamp added to the packet input from the time stamp adding unit 122. The time stamp correction system 125 statistically processes and corrects the time stamp indicating the arrival time of the packet.

For example, correction may be performed using the correction system and the correction method described in Patent Literature 1. In this correction processing, the time stamp indicating an arrival time of the packet and a count value of the sensor clock of the sensor terminal are statistically processed, and the time stamp is recalculated on the basis of a packet transmission interval and a reference arrival time indicating the arrival time of the head packet.

The time stamp corrected by the time stamp correction system 125 is a real number

value with a limited resolution in a floating point, and is not a limited value used in a server or a defined format.

The time stamp interpolation system 126 includes an acquisition unit 1261, a determination unit 1262, and an interpolation processing unit 1263.

The acquisition unit 1261 acquires the time stamp corrected by the time stamp correction system 125 and the data value at the time stamp.

The determination unit 1262 determines the number N of set time stamps (described later) between the corrected time stamp and the previous corrected time stamp. In a case where the number N of set time stamps between the corrected time stamp and the previous corrected time stamp is limited (for example, N=1), the determination unit 1262 may not be provided.

The interpolation processing unit 1263 executes interpolation processing on the set time stamps determined by the determination unit 1262.

### Time stamp Interpolation Method

A time stamp interpolation method according to the present embodiment will be described with reference to FIG. 2A and FIG. 2B.

FIG. 2A is a flowchart illustrating the time stamp interpolation method according to the present embodiment.

First, data (first data) received at an arbitrary time and a time stamp (first time stamp) corrected after being added to the first data are acquired (step S1_1).

Next, data (second data) received before the first data and a time stamp (second time stamp) corrected after being added to the second data are acquired (step S1_2).

Finally, linear interpolation is performed on the basis of the first time stamp, the value of the first data, the second time stamp, and the value of the second data to acquire a value of data at a set time stamp requested by the sensor system (step S1_3). Details are described below.

FIG. 2B illustrates a relationship between a time stamp and a data value. On the assumption that a corrected time stamp of i-th (i=1, 2 . . . n . . . , n is an integer) received data is T_{correct}[i], a data value acquired at an n-th T_{correct}[n] is F(T_{correct}[n]), and a data value acquired at a continuously acquired (n+1)-th corrected time stamp T_{correct}[n+1] is F(T_{correct}[n+1]). In addition, on the assumption that a j-th (j=1, 2 . . . m . . . , m is an integer) time stamp (hereinafter referred to as a “set time stamp”) requested (set) in accordance with the format in the sensor system is T_{required}[j], an m-th T_{required}[m] time stamp is present between T_{correct}[n] and T_{correct}[n+1].

At this time, a data value F(T_{required}[m]) at T_{required}[m] is represented by Formula (1) using linear interpolation.

$$[ Math . 1 ]$$

$$F ( {T}_{required} [ m ] ) = \frac{{T}_{correct} [ n + 1 ] - {T}_{required} [ m ]}{{T}_{correct} [ n + 1 ] - {T}_{correct} [ n ]} F ( {T}_{correct} [ n ] ) + \frac{{T}_{required} [ m ] - {T}_{correct} [ n ]}{{T}_{correct} [ n + 1 ] - {T}_{correct} [ n ]} F ( {T}_{correct} [ n + 1 ] ) \qquad ( 1 )$$

### Effects

In order to match a corrected time stamp that is a real value with a limited value used in a server or a predetermined format as described above, a method of performing rounding on the corrected time stamp including a floating point with predetermined accuracy is conceivable. However, this method cannot sufficiently take advantage of the effect of time stamp correction.

According to the time stamp interpolation method, the time stamp interpolation system, and the sensor system according to the present embodiment, since linear interpolation is used, time stamps can be easily processed in real time and monotonicity can be maintained. Furthermore, the present invention can be implemented without considering an overshoot that can occur in polynomial interpolation.

### First Example

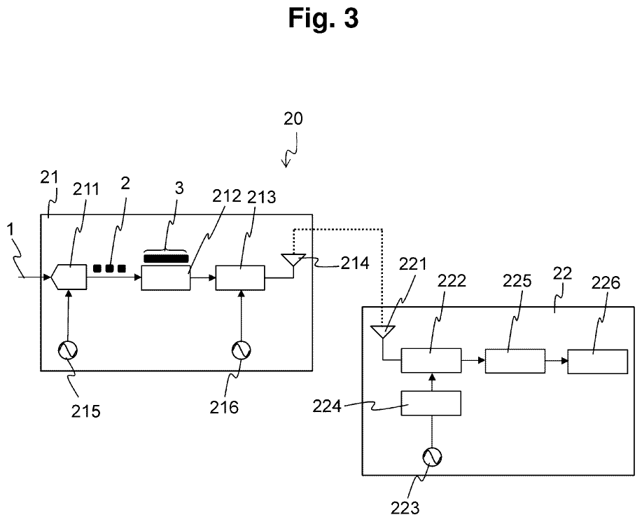

A time stamp interpolation method, a time stamp interpolation system, and a sensor system according to a first example of the present embodiment will be described with reference to FIG. 3 to FIG. 10.

### Configuration of Sensor System

As illustrated in FIG. 3, a sensor system 20 according to the present example includes an intermittent operation terminal 21 and a receiver 22. Signals are transmitted and received between the intermittent operation terminal 21 and the receiver 22 in a wireless or wired manner.

The intermittent operation terminal 21 operates intermittently, and includes an AFE 211, a memory 212, an MPU 213, and a transmission unit 214. Further, an AFE clock 215 connected to the AFE 211 and a packet clock 216 connected to the MPU 213 are provided. The intermittent operation terminal 21 is, for example, a sensor terminal.

The AFE 211 samples and quantizes a measurement signal 1 at a time T_{AFE} counted by the AFE clock 215.

The memory 212 stores the quantized measurement signal 1 as sensor data 2.

Here, one packet 3 includes a predetermined number of pieces of sensor data 2.

The MPU 213 is started at a predetermined interval T_{packet} counted by the packet clock 216 and checks the memory 212. When the sensor data 2 stored in one packet 3 is accumulated in the memory 212, a wireless circuit (for example, Bluetooth Low Energy (BLE)) is started, and the packet 3 is transmitted from the transmission unit 214. As described above, the packet transmission interval time is T_{packet}.

The receiver 22 includes a reception unit 221, a time stamp adding unit 222, a time stamp clock 223, a time stamp correction system 225, and a time stamp interpolation system 226.

After the reception unit 221 receives a packet, the time stamp adding unit 222 adds a time stamp Tₛₜₐₘₚ counted by the time stamp clock 223 and provided via an OS 224 of the receiver to the packet. Here, time stamps are synchronized by the Global Positioning System (GPS), a network time protocol (NTP), a network identity and time zone (NITZ), or the like.

As will be described later, the time stamp correction system 225 corrects the time stamp added to the packet input from the time stamp adding unit 222. At this time, the corrected time stamp is a real number value with limited resolution in a floating point, and is not a limited value used in a server or a defined format.

The time stamp interpolation system 226 interpolates the time stamp corrected by the time stamp correction system 225 as in the first embodiment.

### Configuration and Operation of Time stamp Correction System

The configuration and operation of the time stamp correction system 225 according to the present example will be described below.

First, a case where the time stamp correction system is not provided will be described. In this configuration, TAFE in the analog front end (AFE) clock 215 has a large error due to low power consumption and cost reduction, and may deviate by several minutes at maximum per day. This error becomes a problem in a biological sensor that measures one day or more. Details are described below.

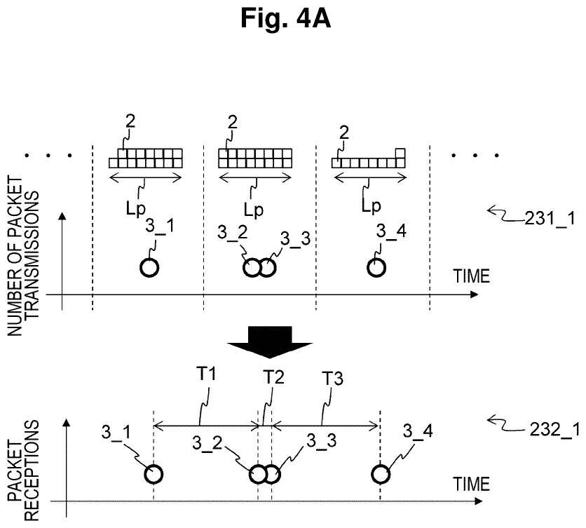

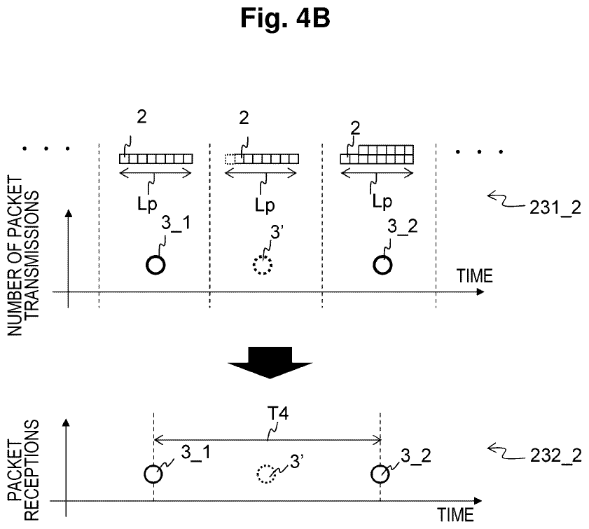

FIG. 4A and FIG. 4B illustrate examples of packet transmission modes 231_1 and 232_1 and reception modes 231_2 and 232_2 in a case where time stamp correction is not performed. Here, the length Lp of one packet corresponds to eight pieces of sensor data 2. Open circles 3_1 to 3_4 indicate packets, and T1 to T4 indicate packet arrival interval times.

In a case where the clock 215 of the AFE is faster than a startup interval of the MPU 213, as illustrated in FIG. 4A, data (corresponding to packets 3_2 and 3_3, for example) corresponding to two or more packets may be held at the time of startup (231_1). In this case, since the packets 3_2 and 3_3 are consecutively transmitted, the packet arrival interval time T2 on the receiver side is considerably reduced (232_1).

In addition, in a case where the clock of the AFE is slower than the startup interval of the MPU, as illustrated in FIG. 4B, the data amount of the packet transmitted at the time of startup is insufficient (dotted white circle 3′). At this time, no packet is transmitted (231_2). In this case, the packet arrival interval time T4 on the receiver side increases (232_2).

As described above, in the configuration without the time stamp correction system, the packet arrival interval time significantly varies depending on the clock of the AFE, and an error due to a transmission error at the time of transmission also occurs, and thus if the time stamp at the time of reception is used as it is, the error increases.

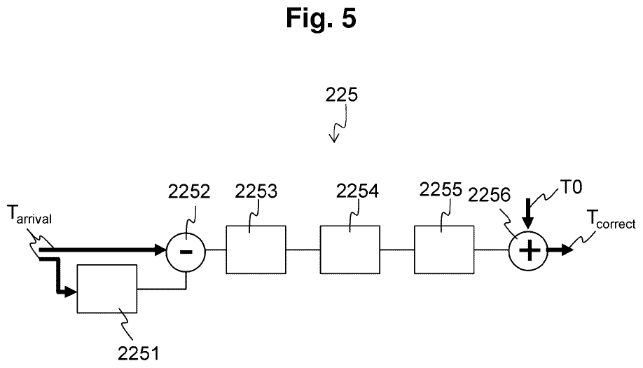

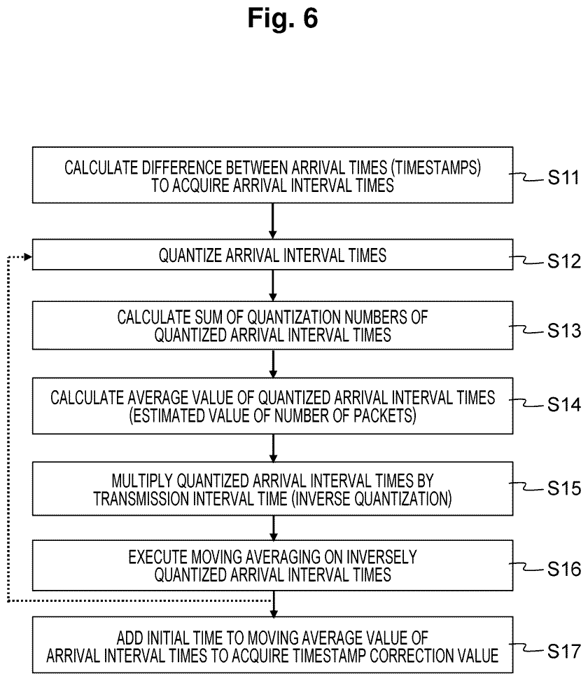

Next, the time stamp correction system 225 and the time stamp correction method according to the present example will be described. FIG. 5 illustrates a configuration of the time stamp correction system 225 according to the present example. Further, FIG. 6 is a flowchart of a time stamp correction method according to the present example.

As illustrated in FIG. 5, the time stamp correction system 225 includes a delay circuit 2251, a subtraction unit 2252, a packet number estimation unit 2253, an arithmetic unit 2254, a moving average filter 2255, and an addition unit 2256.

Here, the time stamp correction system 225 acquires and holds a transmission interval time T_{packet} in advance. The transmission interval time T_{packet} may be stored in advance in the time stamp correction system 225 or may be transmitted from the intermittent operation terminal 21.

An arrival time Tₐᵣᵣᵢᵥₐₗ assigned to a packet is input to the time stamp correction system 225. Here, the arrival time Tₐᵣᵣᵢᵥₐₗ is the same as the time stamp Tₛₜₐₘₚ.

The delay circuit 2251 is configured by a one-stage delay circuit and delays an arrival time Tₐᵣᵣᵢᵥₐₗ (time stamp Tₛₜₐₘₚ) of a received packet (one packet), for example, Tₐᵣᵣᵢᵥₐₗ[i−1].

The subtraction unit 2252 calculates a difference (for example, Tₐᵣᵣᵢᵥₐₗ[i]−Tₐᵣᵣᵢᵥₐₗ[i−1]) between an arrival time Tₐᵣᵣᵢᵥₐₗ (for example, Tₐᵣᵣᵢᵥₐₗ[i]) of the subsequently received packet (another packet) and Tₐᵣᵣᵢᵥₐₗ (for example, Tₐᵣᵣᵢᵥₐₗ[i−1]) delayed by the delay circuit (step S11). The difference in the arrival time Tₐᵣᵣᵢᵥₐₗ (time stamp Tₛₜₐₘₚ) is an arrival interval time Tᵢₙₜₑᵣᵥₐₗ[i]′.

The packet number estimation unit 2253 estimates the number of packets from the arrival interval time Tᵢₙₜₑᵣᵥₐₗ[i].

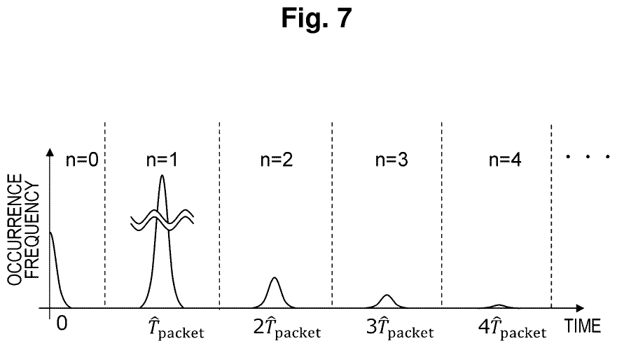

Here, as illustrated in FIG. 7, the arrival interval time is distributed with noise with respect to an integral multiple (n) of a transmission interval time T_{packet} of a packet from a sensor. Therefore, in order to cancel this noise, an estimated value of T_{packet} is set to n=1, and quantization is performed with n=0, 1, 2, . . . and the number of packets estimated to have been transmitted within the transmission interval (step S12).

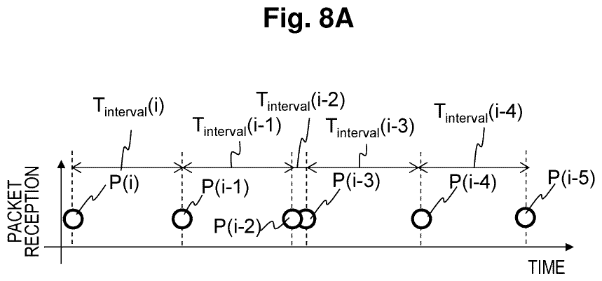

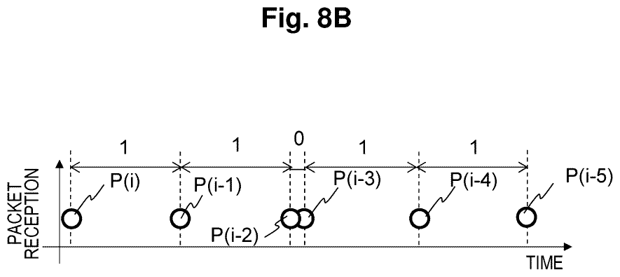

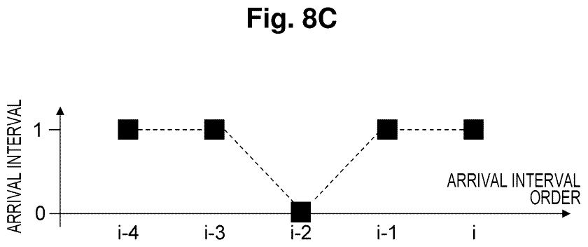

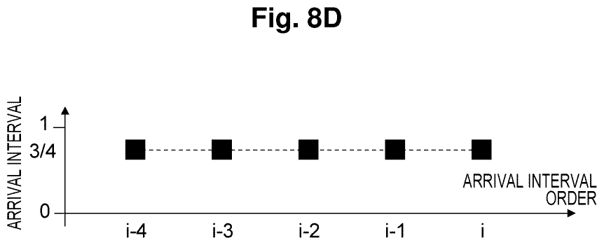

Quantization with the number of packets will be described with reference to FIG. 8A to FIG. 8D using, as an example, packets received in a case where the clock of the AFE is faster than the startup interval of the MPU.

Packets P(i) to P(i−5) are received, and respective arrival interval times are set as Tᵢₙₜₑᵣᵥₐₗ(i) to Tᵢₙₜₑᵣᵥₐₗ(i−4) (FIG. 8A).

First, a time between received packets is set as a transmission interval time T_{packet}.

Each of the arrival interval times Tᵢₙₜₑᵣᵥₐₗ(i) to Tᵢₙₜₑᵣᵥₐₗ(i−4) of the actually received packets is compared with T_{packet}, and when the arrival interval times Tᵢₙₜₑᵣᵥₐₗ(i) to Tᵢₙₜₑᵣᵥₐₗ(i−4) of the packets correspond to n times T_{packet}, the quantization number is set to n (FIG. 8B).

Specifically, since Tᵢₙₜₑᵣᵥₐₗ(i) is equivalent to T_{packet}, the quantization number is “1”. Similarly, since Tᵢₙₜₑᵣᵥₐₗ(i−1) is equivalent to T_{packet}, the quantization number is “1”. Next, since Tᵢₙₜₑᵣᵥₐₗ(i−2) is shorter than T_{packet}, the quantization number is “0”. Next, since Tᵢₙₜₑᵣᵥₐₗ(i−3) is equivalent to T_{packet}, the quantization number is “1”. Similarly, since Tᵢₙₜₑᵣᵥₐₗ(i−4) is equivalent to T_{packet}, the quantization number is “1”.

Accordingly, the quantized arrival interval time varies as 1→1→0→1→1 (FIG. 8C).

Next, the quantization number of the quantized arrival interval times, that is, the total number of packets is calculated (step S13). In this case, 1+1+0+1+1=4 is established. Next, an average of the quantized arrival interval times is calculated as an estimated value of the number of packets (step S14). In this case, since the number of arrived packets is five, the average value is 4/5. Accordingly, the quantized arrival interval times are flattened, and variation in the arrival interval times is curbed (FIG. 8D).

As a result, real values of the arrival interval times are converted into integer values and thus noise can be reduced.

Next, the arithmetic unit 2254 returns (converts) the quantized arrival interval times (integer values) to real values. That is, inverse quantization is executed. Specifically, the quantized arrival interval times (integer values) are multiplied by the transmission interval time T_{packet} (step S15). In the aforementioned example, (4/5)×T_{packet} is calculated.

Next, the inversely-quantized arrival interval times are input to the moving average filter 2255, and moving averaging is executed (step S16). Here, a moving average value is calculated by using the average value of Tᵢₙₜₑᵣᵥₐₗ acquired subsequently as the average value of Tᵢₙₜₑᵣᵥₐₗ.

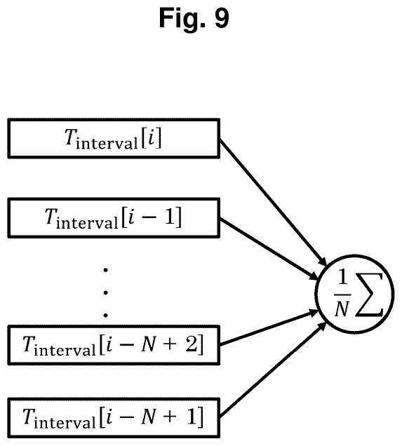

For example, as illustrated in FIG. 9, a moving average is calculated for the arrival interval time from an arbitrary (i-th) arrival interval time Tᵢₙₜₑᵣᵥₐₗ[i] to N−1 earlier arrival interval time Tᵢₙₜₑᵣᵥₐₗ[i−N+1].

Here, as the moving average, a simple moving average, a weighted moving average, an exponential moving average, or the like can be used.

The effect of processing (moving averaging) of the moving average filter 2255 will be described below.

The cutoff frequency Fc of the moving average filter 2255 is designed to be lower than the Nyquist frequency. Here, the Nyquist frequency is a frequency represented by f_{packet}/2 when 1/T_{packet}=f_{packet}.

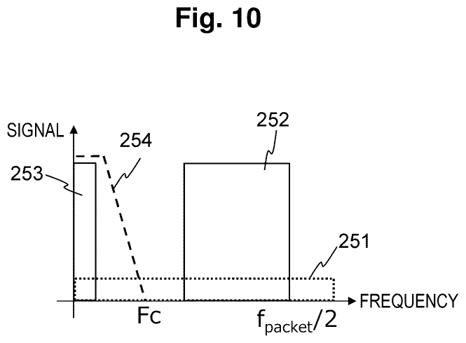

As illustrated in FIG. 10, quantization noise 251 is distributed over the entire frequency in the process of quantization and inverse quantization. The quantization noise 251 is noise caused by information (analog value) lost at the time of quantization.

Furthermore, in a case where sensor data is actually transmitted as a packet, the packet includes a high frequency signal 252 such as a measurement signal and a low frequency signal 253 including information regarding a time stamp. Here, the high frequency signal 252 varies in seconds, and the low frequency signal 253 varies in minutes.

By setting the cutoff frequency Fc of the moving average filter 2255 to be lower than the Nyquist frequency, the moving average filter 2255 can function as a low pass filter to block the high frequency signal 252, transmit the low frequency signal 253, and correct time stamps included in the low frequency signal 253.

Here, since the low frequency signal 253 varies in minutes with respect to the high frequency signal 252 varying in seconds, it is effective to set the cutoff frequency Fc to 1/60 or less of the frequency of the high frequency signal 252.

In addition, since the quantization noise 251 is distributed constant with respect to the frequency, noise can be reduced by f_{packet}/2Fc.

Finally, the addition unit 2256 adds an initial time T₀, which is an offset, to the calculated moving average value of the arrival interval times to acquire a time stamp correction value T_{correct} (step S17).

Here, regarding determination of the initial time T₀, even if the first arrival time is used or even if estimation is performed using the least squares method or the like, only an absolute time error of about several 10 ms occurs, and thus the influence is less than that before application in which a deviation occurs in units of seconds or more.

In addition, in the time stamp correction system 225, a jitter component can be reduced and high-frequency signals can be blocked stably with higher accuracy by configuring the moving average filter 2255 in multiple stages such that the slope 254 of the low pass filter characteristic of the moving average filter 2255 becomes steep. On the other hand, a delay occurs in tracking fluctuation in T_{packet}, but this delay does not cause a problem in the biometric data measurement system that cuts off a DC component.

In addition, since the fluctuation rate of T_{packet} is very low depending on a temperature change and aged deterioration, the influence of narrowing the bandwidth of the filter is small.

Further, in the time stamp correction method, the output of the moving average filter 2255 may be fed back to the step of quantizing the arrival interval times (step S12), and the moving average value may be re-calculated (dotted arrow in FIG. 6). As a result, since T_{packet} changes with the lapse of time, time stamps can be corrected with higher accuracy by performing re-calculation using updated T_{packet}.

The time stamp interpolation method, the time stamp interpolation system, and the sensor system according to the present example have the same effects as those of the first embodiment and the following effects.

According to the time stamp correction system in the present example, noise can be removed, a delay can be mitigated, and a time stamp error can be reduced using the moving average filter.

Furthermore, in a case where a packet transmission error occurs, two or more packets are continuously transmitted immediately after the packet transmission error, and thus Tᵢₙₜₑᵣᵥₐₗ includes temporally correlated noise. Therefore, this noise can be easily removed by the moving average filter 2255. That is, a jitter can be reduced and time stamps can accurately be acquired by using the transmission interval time T_{packet} as a reference rather than using an arrival time including a noise and the delay as it is.

Further, it is useful in a case where it is necessary to correct a time stamp in real time in a system in which a packet arrives on a stream. In addition, it is useful in that an applicable application range is wider than that of a system that performs batch processing on a server.

In addition, since signal processing is basically configured by a delay and a product-sum operation, acceleration processing using a digital signal processor (DSP) can be applied, which is suitable for real-time data processing.

In addition, since correction is executed using a clock synchronized by GPS, NIP, NITZ, or the like, correction can be performed with high accuracy.

### Second Example

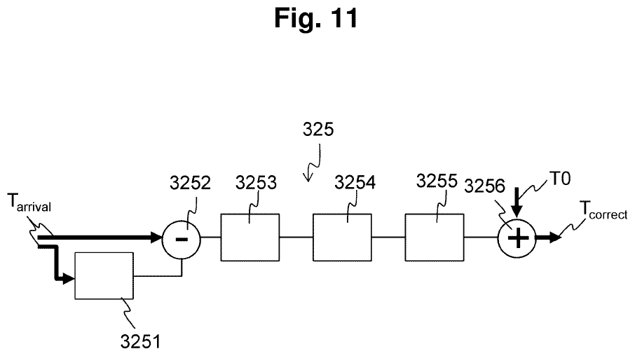

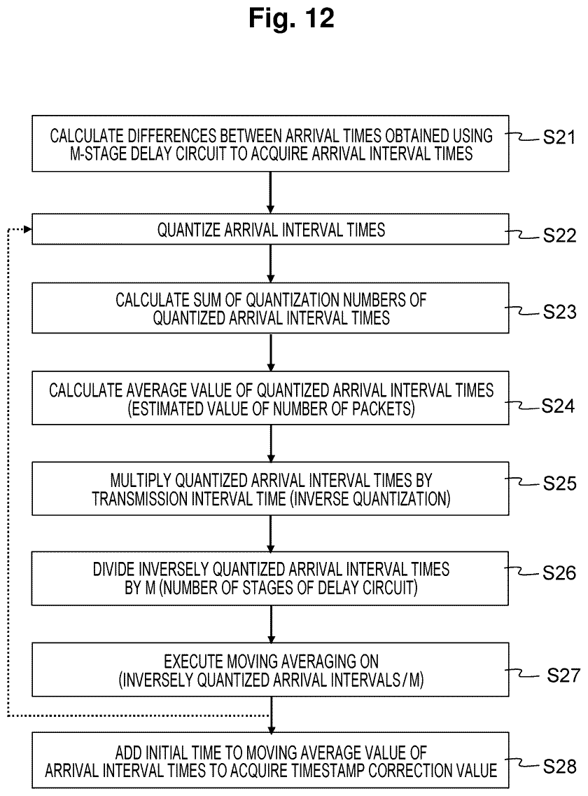

A time stamp interpolation method, a time stamp interpolation system, and a sensor system according to a second example of the present embodiment will be described with reference to FIG. 11 and FIG. 12. The sensor system 30 according to the present example has the same configuration as that of the first example except for the configuration of a time stamp correction system 325.

### Configuration and Operation of Time stamp Correction System

FIG. 11 illustrates a configuration of the time stamp correction system 325 according to the present example. In addition, FIG. 12 is a flowchart of the time stamp correction method according to the present example.

As illustrated in FIG. 11, the time stamp correction system 325 includes a multi-stage delay circuit 3251, a subtraction unit 3252, a packet number estimation unit 3253, an arithmetic unit 3254, a moving average filter 3255, and an addition unit 3256.

The time stamp correction system 325 receives, as an input, an arrival time Tₐᵣᵣᵢᵥₐₗ (time stamp Tₛₜₐₘₚ) assigned to a packet.

The delay circuit 3251 is configured as an M-stage delay circuit and delays Tₐᵣᵣᵢᵥₐₗ (for example, Tₐᵣᵣᵢᵥₐₗ[i−1]) input thereto. Here, Tₐᵣᵣᵢᵥₐₗ is the same as Tₛₜₐₘₚ.

The subtraction unit 3252 uses the output of the M-stage delay circuit to calculate an arrival time difference, that is, an arrival interval time (step S21). As a result, M arrival interval times are obtained.

The packet number estimation unit 3253 quantizes the arrival interval times and calculates an average value of the quantization numbers as an estimated value of the number of packets (steps S22 to S24).

Next, the arithmetic unit 3254 multiplies the quantized arrival interval times by a transmission interval time T_{packet} and performs inverse quantization thereon to convert the quantized arrival interval times into real values (step S25).

Here, as described above, since the arrival interval times are multiplied by M by the M-stage delay circuit, the quantized arrival interval times are multiplied by the value of T_{packet} and divided by M (step S26).

Next, the arrival interval times inversely quantized and divided by M are input to the moving average filter 3255, and moving averaging is executed (step S27).

Finally, the addition unit 3256 acquires a time stamp correction value T_{correct} by adding an initial time T₀, which is an offset, to the calculated moving average value of the arrival interval times (step S28).

Here, as in the first embodiment, the output of the moving average filter 3255 may be fed back to the step of quantizing the arrival interval times (step S22), and the moving average value may be re-calculated (dotted arrow in FIG. 12).

The time stamp interpolation method, the time stamp interpolation system, and the sensor system according to the present example have the same effects as those of the first embodiment and the following effects.

According to the time stamp correction system in the present example, noise can be removed, a delay can be mitigated, and a time stamp error can be reduced using the moving average filter.

Furthermore, the multi-stage delay circuit can remove a correlation noise before the number of packets is quantized. In addition, since data multiplied by M is multiplied by 1/M in inverse quantization, noise itself due to the inverse quantization can be reduced.

In addition, in the time stamp correction system, a delay of M stages is required in the process of estimating the number of packets, and thus noise is reduced as the number of stages (M stages) of the delay circuit increases, whereas real-time properties are reduced. Therefore, it is necessary to adjust the number of stages (M stages) of the delay circuit depending on the application. However, since fluctuation in T_{packet} to be tracked is in units of minutes, it is considered that the real-time property is not affected if delay is about 10 seconds.

### Second Embodiment

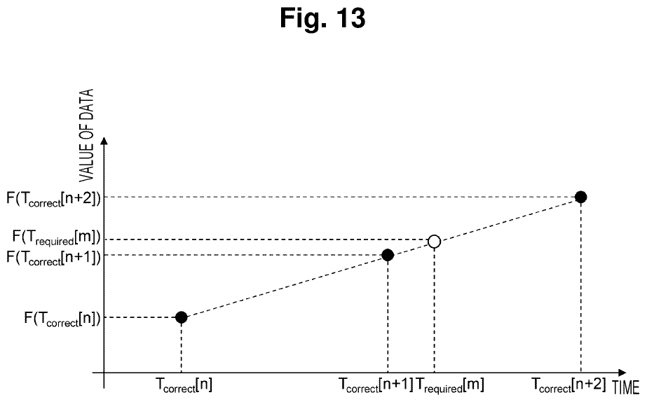

A time stamp interpolation method, a time stamp interpolation system, and a sensor system according to a second embodiment of the present invention will be described with reference to FIG. 13. Configurations of the time stamp interpolation system and the sensor system according to the present embodiment are the same as those of the first embodiment.

### Time stamp Interpolation Method

A time stamp interpolation method according to the present embodiment will be described with reference to FIG. 13.

The time stamp interpolation method according to the present embodiment is applied when the transmission interval T_{packet} is fast. As illustrated in FIG. 13, since the interval between corrected time stamps T_{correct}[n] and T_{correct}[n+1] is narrowed, a set time stamp T_{required}[j] is not present between the corrected time stamps T_{correct}[n] and T_{correct}[n+1].

The m-th set time stamp T_{required}[m] is present between the corrected time stamp T_{correct}[n+1] and the subsequently obtained T_{correct}[n+2].

Therefore, a data value F(T_{required}[m]) at T_{required}[m] is represented by Formula (2) according to linear interpolation using the two time stamps T_{correct}[n+1] and T_{correct}[n+2] closest to T_{required}[m].

$$[ Math . 2 ]$$

$$F ( {T}_{required} [ m ] ) = \frac{{T}_{correct} [ n + 2 ] - {T}_{required} [ m ]}{{T}_{correct} [ n + 2 ] - {T}_{correct} [ n + 1 ]} F ( {T}_{correct} [ n + 1 ] ) + \frac{{T}_{required} [ m ] - {T}_{correct} [ n + 1 ]}{{T}_{correct} [ n + 2 ] - {T}_{correct} [ n + 1 ]} F ( {T}_{correct} [ n + 2 ] ) \qquad ( 2 )$$

In this manner, when the corrected time stamp T_{correct}[n+1] is acquired, if the set time stamp T_{required}[j] is not present between the previous time stamp T_{correct}[n] and the time stamp T_{correct}[n+1], interpolation processing using T_{correct}[n+1] and T_{correct}[n+2] may be performed on the set time stamp T_{required}[j] present in T_{correct}[n+1] and T_{correct}[n+2] to be obtained subsequently, without performing interpolation processing using T_{correct}[n] and T_{correct}[n+1].

Here, in sensing by the intermittent operation terminal, in a case where a polynomial is used for interpolation with respect to the three corrected time stamps T_{correct}[n], T_{correct}[n+1], and T_{correct}[n+2], there is a possibility of being affected by overshoot and noise.

According to the time stamp interpolation method, the time stamp interpolation system, and the sensor system according to the present embodiment, linear interpolation is used, and thus the influence of overshoot and noise can be curbed.

### Third Embodiment

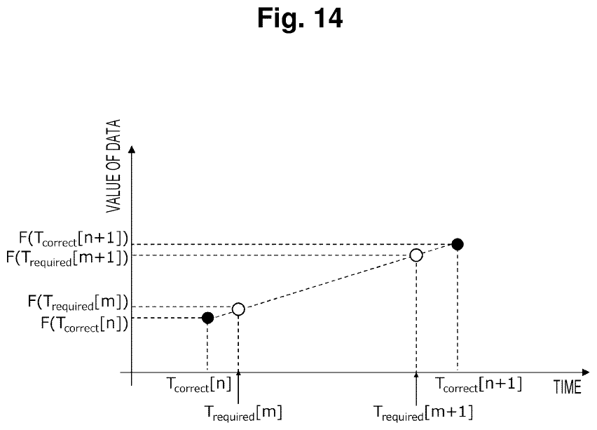

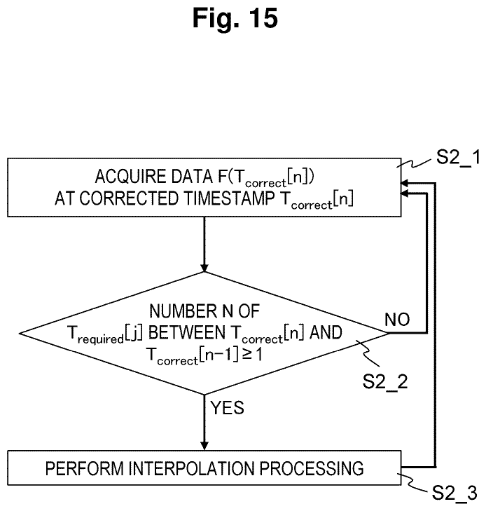

A time stamp interpolation method, a time stamp interpolation system, and a sensor system according to a third embodiment of the present invention will be described with reference to FIG. 14 and FIG. 15. Configurations of the time stamp interpolation system and the sensor system according to the present embodiment are the same as those of the first embodiment.

### Time stamp Interpolation Method

The time stamp interpolation method according to the present embodiment will be described with reference to FIG. 14 and FIG. 15.

The time stamp interpolation method according to the present embodiment is applied when the transmission interval T_{packet} is slow. As illustrated in FIG. 14, since the interval between corrected time stamps T_{correct}[n] and T_{correct}[n+1] is increased, a plurality of, for example, two set time stamps T_{required}[m] and T_{required}[m+1] is present between the corrected time stamps T_{correct}[n] and T_{correct}[n+1].

Data values F(T_{required}[m]) and F(T_{required}[m+1]) at the set time stamps T_{required}[m] and T_{required}[m+1] are represented by Formulas (3) and (4).

$$[ Math . 3 ]$$

$$F ( {T}_{required} [ m ] ) = \frac{{T}_{correct} [ n + 1 ] - {T}_{required} [ m ]}{{T}_{correct} [ n + 1 ] - {T}_{correct} [ n ]} F ( {T}_{correct} [ n ] ) + \frac{{T}_{required} [ m ] - {T}_{correct} [ i ]}{{T}_{correct} [ n + 1 ] - {T}_{correct} [ n ]} F ( {T}_{correct} [ n + 1 ] ) \qquad ( 3 )$$

$$[ Math . 4 ]$$

$$F ( {T}_{required} [ m + 1 ] ) = \frac{{T}_{correct} [ n + 1 ] - {T}_{required} [ m + 1 ]}{{T}_{correct} [ n + 1 ] - {T}_{correct} [ n ]} F ( {T}_{correct} [ n ] ) + \frac{{T}_{required} [ m + 1 ] - {T}_{correct} [ n ]}{{T}_{correct} [ n + 1 ] - {T}_{correct} [ n ]} F ( {T}_{correct} [ n + 1 ] ) \qquad ( 4 )$$

In this manner, in a case where the two set time stamps T_{required}[m] and T_{required}[m+1] are present between the corrected time stamps T_{correct}[n] and T_{correct}[n+1], interpolation can be performed using two formulas. Further, in a case where a plurality of (for example, N) set time stamps T_{required}[m] to T_{required}[m+N−1] are present between T_{correct}[n] and T_{correct}[n+1], interpolation can be performed using a plurality of (for example, N) formulas.

As described above, in the present embodiment, when a new packet is acquired, it is important to ascertain the number of set time stamps present between a time stamp to be added and corrected and a time stamp to be added and corrected immediately before.

FIG. 15 is a flowchart of the time stamp interpolation method according to the present embodiment.

First, after a packet is received and a time stamp is added, the time stamp is corrected. As a result, a data value F(T_{correct}[n]) is acquired at the corrected time stamp T_{correct}[n] (step S2_1).

Next, the number N of set time stamps T_{required} is checked between the corrected time stamp T_{correct}[n] and the previous corrected time stamp T_{correct}[n−1] (step S2_2).

In a case where there is no set time stamp T_{required}(N=0), a data value F(T_{correct}) is newly acquired at the corrected time stamp T_{correct} (step S2_1).

In a case where there are N set time stamps T_{required} (N is 1 or more), interpolation processing is performed on each of the set time stamps T_{required}[m] to T_{required}[m+N−1] using Formula (5) based on Formulas (3) and (4) to acquire data values F(T_{required}[m]) to F(T_{required}[m+N−1]) (step S2_3).

$$[ Math . 5 ]$$

$$F ( {T}_{required} [ m + N - 1 ] ) = \frac{{T}_{correct} [ n ] - {T}_{required} [ m + N - 1 ]}{{T}_{correct} [ n ] - {T}_{correct} [ n - 1 ]} F ( {T}_{correct} [ n - 1 ] ) + \frac{{T}_{required} [ m + N - 1 ] - {T}_{correct} [ n - 1 ]}{{T}_{correct} [ n ] - {T}_{correct} [ n - 1 ]} F ( {T}_{correct} [ n ] ) \qquad ( 5 )$$

Here, rounding of the data value F(T_{required}[j]) is performed as necessary.

Subsequently, a data value F(T_{correct}) is acquired at the corrected time stamp T_{correct} (step S2_1).

When reception of a packet (data) ends, the above-described time stamp interpolation processing ends.

The flowchart of the above-described time stamp interpolation method is not limited to the present embodiment and can be applied to the first and second embodiments. In the above-described flowchart (FIG. 15), a case where there is one set time stamp T_{required} between T_{correct}[n] and T_{correct}[n−1] corresponds to the first embodiment. Further, when the data value F(T_{correct}[n+1]) is newly acquired at the corrected time stamp T_{correct}[n+1] in a case where there is no set time stamp T_{required} between T_{correct}[n] and T_{correct}[n−1] (N=0), a case where there is one set time stamp T_{required} between T_{correct}[n+1] and T_{correct}[n] corresponds to the second embodiment.

According to the time stamp interpolation method, the time stamp interpolation system, and the sensor system according to the present embodiment, calculation is performed every time one packet arrives, and a time stamp can be processed in real time. A processing delay can be curbed to about one sampling time. Therefore, the time stamp interpolation method according to the present embodiment is useful in an application field in which real-time processing is required, such as industrial equipment and medical equipment.

In addition, since the time interval of time stamps is defined to be constant in the data format, sampling data at non-uniform time intervals can be converted into sampling data at uniform time intervals. As a result, the present invention can be applied to evaluation of operation accuracy or the like of hardware. For example, when an AD converter is evaluated, noise or spurious due to coherent sampling to be used can be evaluated. This indicates that this hardware evaluation method can be applied to a network correction method.

Since a calculation error in the time stamp interpolation method according to the present embodiment is limited by the second-order derivative, the calculation error can be curbed by a configuration using a low pass filter for data processing (time stamp interpolation system). Therefore, the time stamp interpolation method according to the present embodiment is useful, for example, in a sensor network.

### Fourth Embodiment

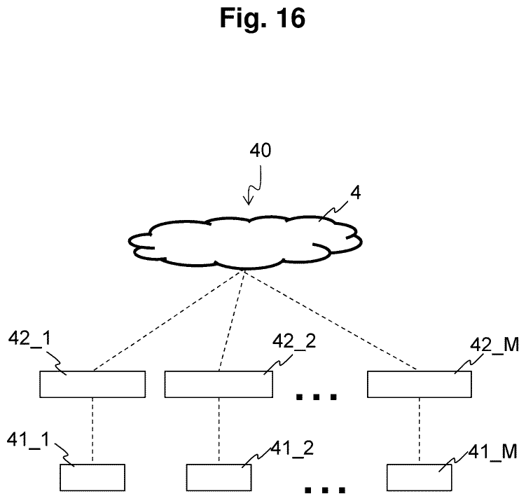

A sensor system according to a fourth embodiment of the present invention will be described with reference to FIG. 16.

### Configuration of Sensor System

The sensor system 40 according to the present embodiment is an example of a network configuration in which the time stamp interpolation methods according to the first to third embodiments are performed on a mobile information terminal such as a smartphone.

As illustrated in FIG. 16, the sensor system 40 includes intermittent operation terminals 41_1 to 41_M and mobile information terminals 42_1 to 42_M such as smartphones, and each of the mobile information terminals 42_1 to 42_M includes the time stamp interpolation system, the time stamp correction system, and the time stamp adding unit according to the first embodiment. Here, the time stamp interpolation system according to the second or third embodiment may be provided.

In the sensor system 40, data acquired by the intermittent operation terminals 41_1 to 41_M is collected by the mobile information terminals 42_1 to 42_M. Time stamps are added to the collected data in the mobile information terminals 42_1 to 42_M, the time stamps are corrected, interpolation processing is performed on the corrected time stamps, the data is transmitted to a network system 4, and the data is handled in a form such as a cloud.

According to the sensor system according to the present embodiment, time stamps can be easily processed in real time, and monotonicity can be maintained. As a result, a delay in processing of time stamps can be minimized by local processing, which is effective in a system or the like that locally displays and analyzes data. Therefore, it is useful in application fields such as industrial equipment and medical equipment in which it is important to curb a delay in data display/analysis. In addition, since smartphones have a display function, a value of data or the like can be monitored in real time while being viewed by a technician or a doctor.

Furthermore, in the sensor system according to the present embodiment, one smartphone may be connected to a plurality of sensors to add a time stamp. In this configuration, the influence of delay is significant, and the influence on other applications is also significant. Therefore, a configuration in which one sensor is connected to one smartphone is more desirable than a configuration in which a plurality of sensors are connected to one smartphone.

### Fifth Embodiment

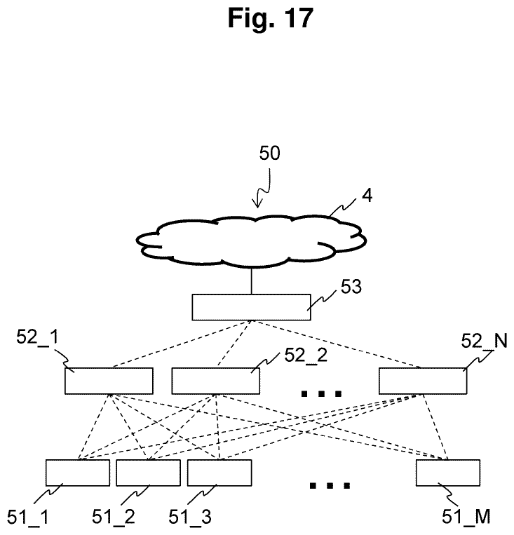

A sensor system according to a fifth embodiment of the present invention will be described with reference to FIG. 17.

### Configuration of Sensor System

The sensor system 50 according to the present embodiment is an example of a multi-stage network configuration using data collection terminals 52_1 to 52_N that collect data from intermittent operation terminals 51_1 to 51_M.

As illustrated in FIG. 17, the sensor system 50 includes the intermittent operation terminals 51_1 to 51_M, the data collection terminals 52_1 to 52_N, and a server 53. Here, the data collection terminals 52_1 to 52_N include a time stamp adding unit, and the server 53 includes the time stamp interpolation system and the time stamp correction system according to the first embodiment. Here, the time stamp interpolation system according to the second or third embodiment may be provided.

In the sensor system 50, data acquired by the intermittent operation terminals 51_1 to 52_M is collected by the data collection terminals 52_1 to 52_N, and time stamps are added thereto. The data to which the time stamps have been added is transmitted to the server 53, the time stamps are corrected by the server 53, interpolation processing is performed on the corrected time stamps, the data is transmitted to the network system 4, and the data is handled in a form such as a cloud.

As described above, the sensor system 50 has a configuration in which the data collection terminals 52_1 to 52_N execute only adding of time stamps, and the server 53 corrects the time stamps and interpolates the time stamps.

According to the sensor system according to the present embodiment, time stamps can be easily processed in real time, and monotonicity can be maintained. Furthermore, since the data collection terminals can allocate resources only to adding a time stamp, deterioration of time stamp accuracy due to arithmetic operation can be prevented under an environment in which a plurality of intermittent operation terminals (sensors and the like) are connected to the data collection terminals.

In addition, in a normal sensor network, a higher server (closer to a network system) has a higher arithmetic operation capability, and a lower sensor (farther from the network system) has a lower arithmetic operation capability, and thus if correction processing and interpolation processing are executed on time stamps by a server having a higher arithmetic operation capability, it is useful in that resources can be concentrated.

In particular, in a case where packet transmission fails more frequently when a plurality of sensors are connected, time stamps can be corrected and transmitted again after packet transmission fails, and thus noise becomes correlated and accuracy can be maintained.

Although an example in which the time stamp correction systems and the time stamp correction methods in the first and second examples are applied to the first embodiment has been described in the embodiment of the present invention, the present invention is not limited thereto, and the time stamp correction system and the time stamp correction method may be applied to the second or third embodiment.

Although an example of using the time stamp correction system and correction method thereof described in Patent Literature 1, and the time stamp correction system and the correction method thereof in the first and second examples has been described in the embodiment of the present invention, the present invention is not limited thereto, and other correction systems and correction methods thereof may be used.

Although examples of the structure, dimensions, and the like of each component have been described in the configurations of the time stamp interpolation method, the time stamp interpolation system, and the sensor system in the embodiment of the present invention, the present invention is not limited thereto. It is sufficient that functions and effects of the time stamp interpolation method, the time stamp interpolation system, and the sensor system are exhibited.

### INDUSTRIAL APPLICABILITY

The present invention relates to a time stamp interpolation method, a time stamp interpolation system, and a sensor system, and can be applied to a system that transmits and receives data acquired by an intermittent operation terminal such as a sensor and a communication system.

### REFERENCE SIGNS LIST

10 Sensor system

1-8. (canceled)

9. A method for interpolating time stamps added to respective data transmitted and received in a sensor system, the method comprising:
acquiring a first data received at an arbitrary time and a first time stamp associated with the first data;
acquiring a second data received before the first data and a second time stamp associated with the second data;
performing linear interpolation on the basis of the first time stamp, a value of the first data, the second time stamp, and a value of the second data, to acquire values of data at set time stamps requested by the sensor system; and
outputting the values of data associated with the respective set time stamps to another device involved in the sensor system.

10. The method according to claim 9, further comprising:
acquiring a number of set time stamps between the first time stamp and the second time stamp;
wherein the linear interpolation on the basis of the first time stamp, the value of the first data, the second time stamp, and the value of the second data is performed to acquire the values of data at the set time stamps requested by the sensor system when the number of the set time stamps is one or more.

11. The method according to claim 9, wherein data values at the set time stamps are represented by Formula (A),
$$F ( {T}_{required} [ m + N - 1 ] ) = \frac{{T}_{correct} [ n ] - {T}_{required} [ m + N - 1 ]}{{T}_{correct} [ n ] - {T}_{correct} [ n - 1 ]} F ( {T}_{correct} [ n - 1 ] ) + \frac{{T}_{required} [ m + N - 1 ] - {T}_{correct} [ n - 1 ]}{{T}_{correct} [ n ] - {T}_{correct} [ n - 1 ]} F ( {T}_{correct} [ n ] ) \qquad ( A )$$
where, for n-th received data, T_{correct}[n] is the first time stamp, T_{correct}[n−1] is the second time stamp, F(T_{correct}[n]) is the value of the first data, F(T_{correct}[n−1]) is the value of the second data, T_{required}[m+N−1] is the (m+N−1)-th set time stamp, F(T_{required}[m+N−1]) is the value of the data at the set time stamp, and N is the number of set time stamps present between the first time stamp and the second time stamp.

12. The method according to claim 9, further comprising:
calculating differences between the time stamps as arrival interval times;
quantizing the arrival interval times;
calculating an average value of quantization numbers of the quantized arrival interval times as an estimated value of a number of packets;
multiplying the transmission interval time by the estimated value of the number of packets to calculate inversely quantized arrival interval times;
executing moving averaging on the inversely quantized arrival interval times; and
adding an initial time to a value obtained by the moving averaging.

13. A time stamp interpolation system for interpolating time stamps added to respective data transmitted and received in a sensor system, the time stamp interpolation system comprising:
an acquisition circuit configured to acquire data received and time stamps added to the data and acquire second data received before the first data and a second time stamp corrected after being added to the second data; and
an interpolation processing circuit configured to perform linear interpolation on the basis of a value of a first data received at an arbitrary time, a first time stamp associated with the first data, a value of a second data received before the first data, and a second time stamp associated with the second data, to acquire values of data at set time stamps requested by the sensor system.

14. A sensor system comprising:
an intermittent operation terminal configured to transmit data;
a receiver configured to receive the data;
a time stamp adding circuit configured to add a time stamp to each of the data;
a time stamp correction system configured to correct a first time stamp associated with a first data and a second time stamp associated with a second data received before the first data to obtain a first corrected time stamp a second corrected time stamp; and
the time stamp interpolation system according to claim 13, wherein the time stamp interpolation system performs linear interpolation on the basis of a value of the first data, the first time stamp associated with the first data, a value of the second data, and the second time stamp associated with the second data.

15. The sensor system according to claim 14, wherein the time stamp adding circuit, the time stamp correction system, and the time stamp interpolation system are installed in a mobile information terminal.

16. The sensor system according to claim 14, wherein the time stamp adding circuit is installed in a data collection terminal; and
the time stamp correction system and the time stamp interpolation system are installed in a server.

17. The time stamp interpolation system according to claim 13, wherein data values at the set time stamps are represented by Formula (A),
$$F ( {T}_{required} [ m + N - 1 ] ) = \frac{{T}_{correct} [ n ] - {T}_{required} [ m + N - 1 ]}{{T}_{correct} [ n ] - {T}_{correct} [ n - 1 ]} F ( {T}_{correct} [ n - 1 ] ) + \frac{{T}_{required} [ m + N - 1 ] - {T}_{correct} [ n - 1 ]}{{T}_{correct} [ n ] - {T}_{correct} [ n - 1 ]} F ( {T}_{correct} [ n ] ) \qquad ( A )$$
where, for n-th received data, T_{correct}[n] is the first time stamp, T_{correct}[n−1] is the second time stamp, F(T_{correct}[n]) is the value of the first data, F(T_{correct}[n−1]) is the value of the second data, T_{required}[m+N−1] is the (m+N−1)-th set time stamp, F(T_{required}[m+N−1]) is the value of the data at the set time stamp, and N is the number of set time stamps present between the first time stamp and the second time stamp.

18. The sensor system according to claim 14, wherein the time stamp correction system comprises:
a subtraction circuit configured to calculate differences between the time stamps as arrival interval times;
a packet number estimation circuit configured to quantize the arrival interval times, and calculate an average value of quantization numbers of the quantized arrival interval times as an estimated value of a number of packets;
an arithmetic circuit configured to multiply the transmission interval time by the estimated value of the number of packets to calculate inversely quantized arrival interval times;
a moving average filter configured to execute moving averaging on the inversely quantized arrival interval times; and
an adder configured to add an initial time to a value obtained by the moving averaging.

19. The sensor system according to claim 14, wherein data values at the set time stamps are represented by Formula (A),
$$F ( {T}_{required} [ m + N - 1 ] ) = \frac{{T}_{correct} [ n ] - {T}_{required} [ m + N - 1 ]}{{T}_{correct} [ n ] - {T}_{correct} [ n - 1 ]} F ( {T}_{correct} [ n - 1 ] ) + \frac{{T}_{required} [ m + N - 1 ] - {T}_{correct} [ n - 1 ]}{{T}_{correct} [ n ] - {T}_{correct} [ n - 1 ]} F ( {T}_{correct} [ n ] ) \qquad ( A )$$
where, for n-th received data, T_{correct}[n] is the first time stamp, T_{correct}[n−1] is the second time stamp, F(T_{correct}[n]) is the value of the first data, F(T_{correct}[n−1]) is the value of the second data, T_{required}[m+N−1] is the (m+N−1)-th set time stamp, F(T_{required}[m+N−1]) is the value of the data at the set time stamp, and N is the number of set time stamps present between the first time stamp and the second time stamp.

20. The method according to claim 10, wherein data values at the set time stamps are represented by Formula (A),
$$F ( {T}_{required} [ m + N - 1 ] ) = \frac{{T}_{correct} [ n ] - {T}_{required} [ m + N - 1 ]}{{T}_{correct} [ n ] - {T}_{correct} [ n - 1 ]} F ( {T}_{correct} [ n - 1 ] ) + \frac{{T}_{required} [ m + N - 1 ] - {T}_{correct} [ n - 1 ]}{{T}_{correct} [ n ] - {T}_{correct} [ n - 1 ]} F ( {T}_{correct} [ n ] ) \qquad ( A )$$
where, for n-th received data, T_{correct}[n] is the first time stamp, T_{correct}[n−1] is the second time stamp, F(T_{correct}[n]) is the value of the first data, F(T_{correct}[n−1]) is the value of the second data, T_{required}[m+N−1] is the (m+N−1)-th set time stamp, F(T_{required}[m+N−1]) is the value of the data at the set time stamp, and N is the number of set time stamps present between the first time stamp and the second time stamp.

21. The method according to claim 10, further comprising:
calculating differences between the time stamps as arrival interval times;
quantizing the arrival interval times;
calculating an average value of quantization numbers of the quantized arrival interval times as an estimated value of a number of packets;
multiplying the transmission interval time by the estimated value of the number of packets to calculate inversely quantized arrival interval times;
executing moving averaging on the inversely quantized arrival interval times; and
adding an initial time to a value obtained by the moving averaging.
